(19) United States
(12) Patent Application Publication
(10) Pub. No.: US 2016/0036109 A1
(43) Pub. Date: Feb. 4, 2016

(54) LITHIUM-AIR BATTERY

(71) Applicant: HYUNDAI MOTOR COMPANY, Seoul (KR)

(72) Inventors: Dong Hui Kim, Suwon (KR); Dae Gun Jin, Uiwang (KR); Jun Ki Rhee, Suwon (KR); Kyoung Han Ryu, Uiwang (KR)

(21) Appl. No.: 14/569,680

(22) Filed: Dec. 13, 2014

(30) Foreign Application Priority Data
Aug. 1, 2014 (KR) 10-2014-0098731

(51) Int. Cl. H01M 12/08

(52) U.S. Cl. CPC H01M 12/08

(57) ABSTRACT

Disclosed is a lithium-air battery or particularly, a high voltage lithium-air battery of a laminated type with a high density. The lithium-air battery may be constructed by laminating a plurality of cells, each of which may comprises a cathode that uses oxygen in air as an active material, a lithium metal anode, a separation film interposed between the cathode and the anode and an electrolyte for ion transmission. In particular, an electrically conductive bipolar plate having a flow path for supplying air to the cathode is interposed between a cathode and an anode of adjacent cell when the cells are laminated and an air inlet manifold for distributing air to the air flow path of the respective bipolar plate and an air outlet manifold for allowing the air passing through the air flow path of the respective bipolar plate to be discharged are provided in the lithium-air battery.

### CROSS-REFERENCE TO RELATED APPLICATION

This application claims under 35 U.S.C. §119(a) the benefit of Korean Patent Application No. 10-2014-0098731 filed on Aug. 1, 2014, the entire contents of which are incorporated herein by reference.

### TECHNICAL FIELD

The present invention relates to a lithium-air battery. The lithium-air battery may be applied as a high voltage package by laminating series of unit cells, each of the cells comprises a cathode, an anode, a separation film and an electrolyte.

### BACKGROUND

A lithium-air battery is a cell having a cathode using oxygen in air as an active material and oxidation/reduction reaction of lithium ion and oxide lithium is performed on the cathode to charge/discharge the cell.

A lithium ion battery in a related art may provide energy storage demand of Electric Vehicle (VE) or Plug-in Hybrid Electric Vehicle (PHEV) for a short distance driving. However, the energy storage demand in a vehicle for a long distance driving may not be provided due to insufficient energy storage amount. As such, an energy storage device capable of storing substantial amount of energy is in need.

Among the currently developed energy storage devices, the lithium-air battery has a substantial theoretical capacity and exhibits greater energy density than a lithium-ion battery, and thus may be reduced in size and weight.

The lithium-air battery has been developed to include an anode capable of absorbing/discharging lithium ions, a cathode that uses oxygen in air as an active material and an electrolyte interposed between the anode and cathode.

In particular, the lithium-air battery not only uses lithium itself as an anode but also does not need to store air of an active material therein and thus may be used as a cell with a high capacity. For example, a theoretical energy density per weight of the lithium-air battery may be about 3500 Wh/kg or greater, which corresponds to about 10 times of the energy density of the lithium-ion battery.

The reaction formula presented below shows the reactions occurring in the cathode and the anode of the lithium-air battery. In detail, the lithium cation that is discharged from lithium metal on the anode when the lithium-air battery is discharged is moved to a cathode through electrolyte and the lithium cation is oxidation-reacted with oxygen in air supplied from atmosphere to produce lithium oxide such as Li₂O or Li₂O₂ and subsequently electron moves from an anode to a cathode through electrical circuit.

Li→Li⁺+e⁻ (anode reaction)

O²+2e⁻+2Li⁺→2Li₂O₂ (cathode reaction)

O² +4e⁻+4Li⁺→2Li₂O (cathode reaction) [Reaction formula]

When a lithium-air battery is applied as an energy storage device, a predetermined supply of oxygen may be a very important factor to maximize performance of the lithium-air battery.

Further, the lithium oxide produced on the cathode of a lithium-air battery may be accumulated on the cathode and then lithium metal may be regenerated on the anode through reverse reactions on the anode and cathode when the battery is charged, thereby repeatedly charging/discharging the battery.

FIG. 1 illustrates an exemplary lithium-air battery having an unit cell, including an air cathode (air electrode) 111, a lithium metal anode 112, a separation film for insulation 113, a gas diffusion layer (GDL) 114, a cathode current collector 115 having an air flow path 115a, an anode current collector 116 and an end plate 117 for fixing and supporting the laminated components.

Further, the separation film 113 is disposed between the cathode 111 and the anode 112 for insulation therebetween, and provides a path for ion transmission with maintaining liquid electrolyte since the separation film 113 is made of porous material through which the liquid electrolyte can transmit.

In the cell configuration as described above, external air is supplied to a cathode through an air flow path of the cathode current collector 115 and the cathode has a porous structure through which the air introduced from outside may transmit. In addition, the cathode and the separation film may contain the liquid electrolyte due to their porous structures.

In the related art, the lithium-air battery has been further developed to have two cathodes at both sides around an anode in addition to the unit cell having one anode and one cathode.

Meanwhile, a connection among cells through a wiring is necessary for implementing a high voltage battery using a plurality of the cells. Further, a subsidiary component such as a jig may be necessary for maintaining the interval between cells at a predetermined distance to supply air, however, the jig may increase volume density of the battery.

For example, in the related art, a configuration of an unit cell has been disclosed and a wiring among cells and a fixing jig for maintaining intervals among cells for the cathode to be exposed to air have been provided as necessary elements when a high voltage battery is formed by electrically connecting the cells in series.

Further, in other example of the related arts, a shape of a lamination type of cells has been introduced, however, a configuration for connecting electrically cells and for supplying air when the cells are laminated has not bene provided.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, in a preferred aspect, the present invention provides a lithium-air battery applied as a high voltage battery by laminating serious of unit cells, each of the cells includes a cathode, an anode, a separation film and an electrolyte.

In a further preferred aspect, the present invention provides a high voltage lithium-air battery of a laminated type with high density. When the high voltage battery package or battery pack is formed, electrical connection in series of a plurality of cells and efficient oxygen supply to the respective cell may be obtained without using subsidiary components such as a wiring and a fixing jig for maintaining the intervals among cells, and thus an entire volume of the battery pack may be reduced.

In one aspect, the present invention provides a lithium-air battery that comprises a plurality of cells, each of the cells may comprise: a cathode that uses oxygen in air as an active material; a lithium metal anode; a separation film interposed between the cathode and the anode; and an electrolyte for ion transmission. In particular, an electrically conductive bipolar plate having a flow path for supplying air to the cathode may be interposed between the cathode and the anode of adjacent cell when the cells are laminated and an air inlet manifold for distributing air to the air flow path of the respective bipolar plate; and an air outlet manifold for allowing the air passing through the air flow path of the respective bipolar plate to be discharged may be provided.

Preferred lithium-air batteries of the present invention may be suitably constructed by laminating a plurality of cells as described herein. In addition, preferred vehicles of the present invention may comprise the preferred lithium-air batteries as described herein.

In particular, an air flow path having an engraved channel structure may be formed on a first surface of the bipolar plate and the first surface of the bipolar plate on which the air flow path is formed may be bonded directly to the cathode or bonded to the cathode with a gas diffusion layer interposed between the cathode and the bipolar plate.

In addition, an electrically non-conductive gasket may be interposed between the adjacent bipolar plates to be laminated to seal an outskirt of the components of the respective cell.

Moreover, an air inlet manifold hole and an air outlet manifold hole may be formed through the bipolar plate and the gasket, respectively. When the bipolar plate and the gasket are laminated, the air inlet manifold hole of the bipolar plate and the air outlet manifold hole of the gasket may communicate and may form an air inlet manifold and an air outlet manifold, respectively.

Further, the air flow path of the bipolar plate may be formed to connect between the air inlet manifold hole of the bipolar plate and the air outlet manifold hole of the gasket.

A cathode current collector and an anode current collector may be laminated at both outer ends of a structure formed by laminating a plurality of cells and bipolar plates, respectively. Accordingly, the cathode current collector may be bonded to the bipolar plate and the anode current collector may be bonded to the anode or to an electrically conductive insertion plate bonded to the anode.

Electrically non-conductive end plates may be assembled to both outer ends of a structure formed by laminating a plurality of cells and bipolar plates to fix and support the laminated components while the cathode current collector and the anode current collector may be interposed.

In addition, the end plate may have an air inlet unit for supplying air to the air inlet manifold and air outlet unit for discharging air which passes through the air flow path of the bipolar plate and then is discharged through the air outlet manifold to outside.

A cooling water flow path through which cooling water flows may be formed inside the bipolar plate. In particular, the cooling water flow path may include: a cooling water inlet manifold such that the cooling water may be distributed to the cooling water flow path of the respective bipolar plate; and a cooling water outlet manifold such that the cooling water may pass through the cooling water flow path of the respective bipolar plate to be discharged.

A cooling water inlet manifold hole and a cooling water outlet manifold hole may be formed through the bipolar plate and the gasket, respectively. The cooling water inlet manifold hole of the bipolar plate and the cooling water outlet manifold hole of the gasket may communicate while the bipolar plate and the gasket are laminated and may form a cooling water inlet manifold and a cooling water outlet manifold, respectively.

In addition, the cooling water flow path of the bipolar plate may be formed to connect between the cooling water inlet manifold hole of the bipolar plate and the cooling water outlet manifold hole of the gasket.

In a further preferred aspect, a method for producing a lithium-air battery may comprise: laminating a plurality of cells, each of the cells comprises a cathode that uses oxygen in air as an active material, a lithium metal anode, a separation film interposed between the cathode and the anode and an electrolyte for ion transmission; and interposing an electrically conductive bipolar plate having an air flow path for supplying air to the cathode between the cathode and an anode of adjacent cell while the cells are laminated. In particular, an air inlet manifold for distributing air to the air flow path of the respective bipolar plate and an air outlet manifold for allowing the air passing through the air flow path of the respective bipolar plate to be discharged are provided in the lithium-air battery.

Other aspects and exemplary embodiments of the invention are discussed infra.

### BRIEF DESCRIPTION OF THE DRAWINGS

The above and other features of the present invention will now be described in detail with reference to various exemplary embodiments thereof illustrated the accompanying drawings which are given hereinbelow by way of illustration only, and thus are not limitative of the present invention, and wherein:

FIG. 1 illustrates a lithium-air battery having an unit cell;

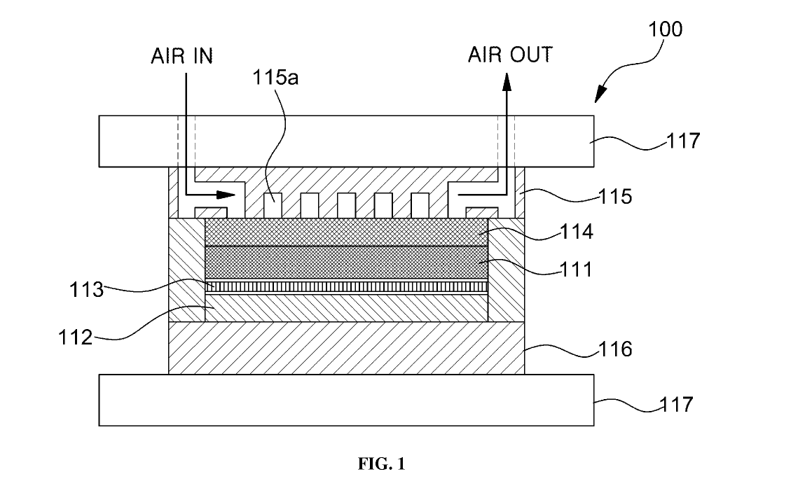

FIG. 2 is a cross-sectional view illustrating an exemplary cell laminated type lithium-air battery according to an exemplary embodiment of the present invention;

FIG. 3 illustrates an exemplary flow path of an exemplary bipolar plate according to an exemplary embodiment of the present invention;

FIG. 4 is a flat view illustrating an exemplary flow path arrangement of an exemplary bipolar plate according to an exemplary embodiment of the present invention;

FIG. 5 is a flat view illustrating an exemplary bipolar plate to which a plurality of flow paths according to an exemplary embodiment of the present invention; and

FIG. 6 is an exemplary graph illustrating discharging capacities when an unit layer cell and an exemplary laminated cell of the present invention are applied.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a lithium-air battery applied as a high voltage battery. The lithium-air battery may comprise a plurality of unit cells and may be manufactured by laminating series of unit cells, each of cells includes a cathode, an anode, a separation film and an electrolyte.

Particularly, the present invention may provide a high voltage lithium-air battery of a laminated type with a high density in which, when forming a high voltage battery package or battery pack, electrical connection in series of a plurality of cells and efficient oxygen supply to the respective cell may be obtained without using subsidiary components such as a wiring and a fixing jig for maintaining the intervals among cells, thereby reducing entire volume of the battery pack.

In an exemplary embodiment, an electrically conductive bipolar plate having air flow path may be interposed between cells and a plurality of cells may be laminated in series to construct a package with a high density. In other words, a plurality of cells may be laminated in series through the bipolar plates to construct a battery package for high power output, and thus, additional wiring may not be used in a high voltage battery package by inserting the bipolar plate between cells.

Further, when forming a lithium-air battery by laminating series of a plurality of cells, a long flow path channel for connecting between an inlet manifold hole and an outlet manifold hole may be engraved on a first surface of the bipolar plate interposed between cells or particularly, on the first surface of the bipolar plate with which cathode of the respective cell or on a gas diffusion layer boded to a cathode may contact. As such, the flow path channel may be used as an air flow path for supplying air to a cathode of a cell contacting a first surface of the bipolar plate.

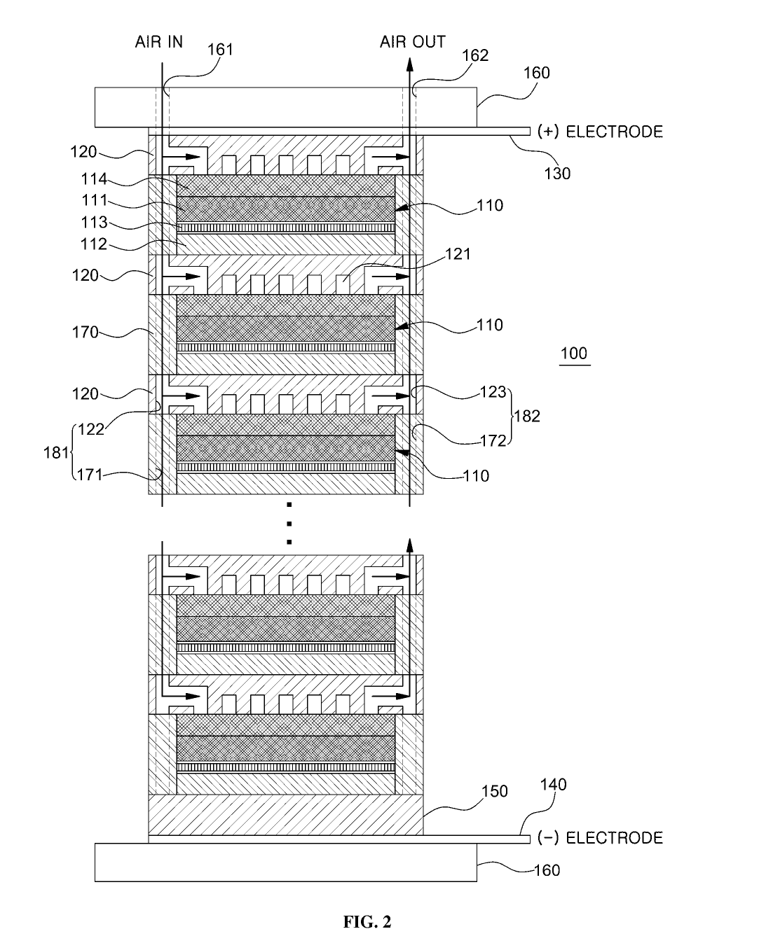

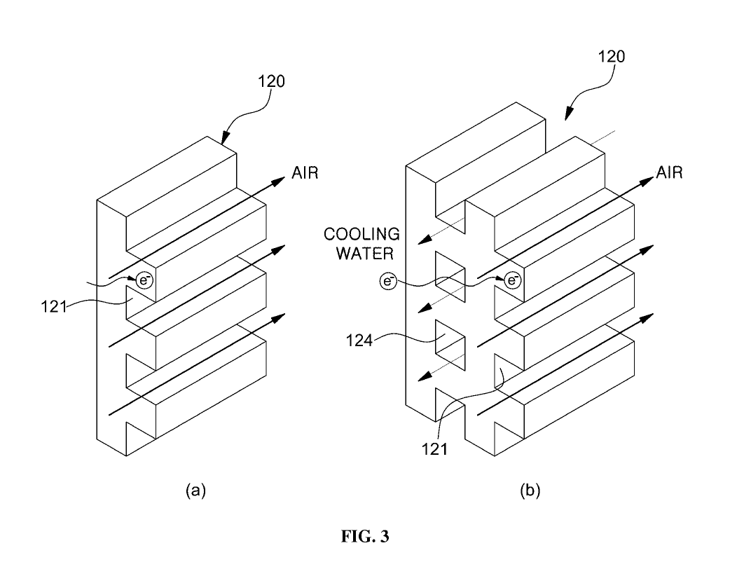

FIG. 2 a cross-sectional view illustrating an exemplary cell laminated type lithium-air battery according to an exemplary embodiment of the present invention and FIG. 3 illustrates an exemplary flow path of an exemplary bipolar plate according to an exemplary embodiment of the present invention.

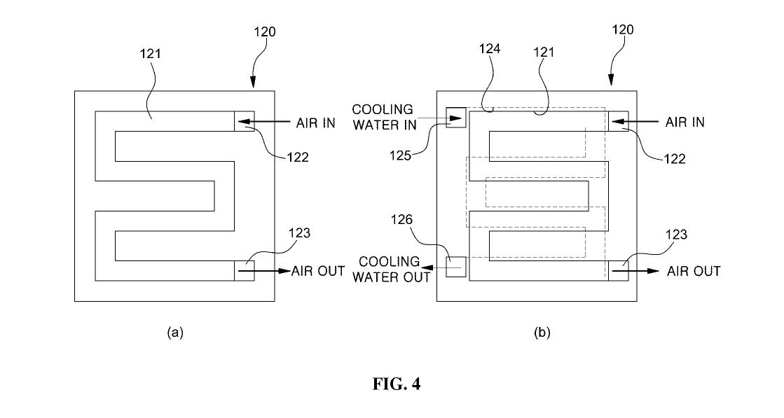

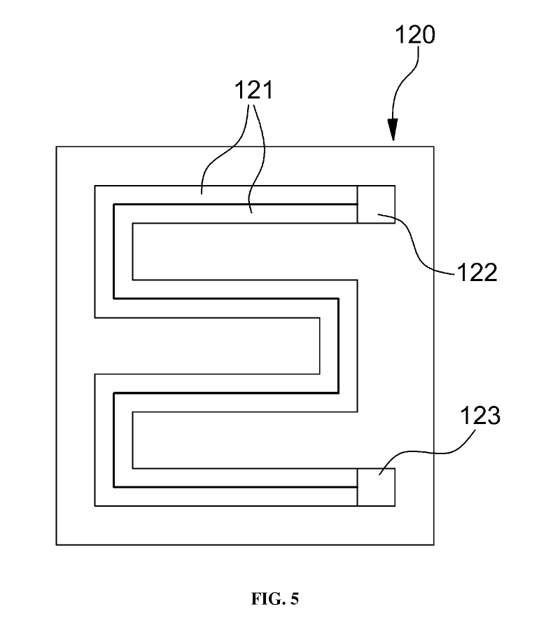

Further, FIG. 4 is a flat view illustrating an exemplary flow path arrangement of an exemplary bipolar plate according to an exemplary n embodiment of the present invention and FIG. 5 is a flat view illustrating an exemplary bipolar plate which includes a plurality of flow paths according to an exemplary embodiment of the present invention.

As shown in FIG. 2, a plurality of cells 110 are laminated when a bipolar plate 120 is interposed between the cells 110, each of which 110 includes an air cathode or air electrode 111 that uses oxygen in air as an active material, a lithium metal anode 112, a separation film 113 interposed between the cathode 111 and the anode 112, and a liquid electrolyte (not shown) filled between the cathode 111 and the anode 112 as main components.

The separation film 113 may be disposed between the cathode 111 and the anode 112 and insulate between the cathode 111 and the anode 112. The separation film 113 may be made of porous material through which liquid electrolyte may transmit, and thus provide a path for ion transmission with maintaining liquid electrolyte.

In the respective cell structure as described above, air may be supplied to the cathode 111 through an air flow path 121 of the bipolar plate 120 which is disposed between adjacent cells 110. The cathode 111 may have a porous structure through which air may transmit wherein the cathode 111 and the separation film 113 may contain liquid electrolyte due to their porous structures.

According to an embodiment of the present invention, the bipolar plate 120 that is interposed between cells 110 may be a plate and the air flow path 121 may be formed on a first surface of the bipolar plate 120. The bipolar plate 120 may be made of an electrically conductive material such graphite or an electrically conductive metal such as stainless steel, nickel, aluminum or the like.

When the bipolar plate 120 is laminated, a first surface of the bipolar plate 120 on which the air flow path 121 is formed may be bonded to a cathode 111 to supply air and a second surface of the bipolar plate 120 may be bonded to an anode 112 of adjacent cell 110, as the bipolar plate 120 may be laminated to transmit electrons between the cathode 111 and the anode 112.

When the bipolar plate 120 is laminated, the first surface of the bipolar plate 120 on which the air flow path 121 is formed may be bonded directly to the cathode 111 to be laminated, or alternatively, to a gas diffusion layer (GDL) 114 may be interposed between the bipolar plate 120 and the cathode 111.

As shown in FIG. 2, the first surface of the bipolar plate 120 on which the air flow path 121 is formed may be laminated and bonded to contact a first surface of the gas diffusion layer 114, and an opposite second surface of the gas diffusion layer 114 may be laminated and bonded to contact the cathode 111.

Further, end plates 160 made of electrically non-conductive material may be bonded to external both ends of the laminated structure, respectively, so as to fix and support the laminated cells and the components of the laminated structure and the bipolar plates 120. Further, a fastening device (not shown) may be arranged for compressing between the end plates 160 on both sides and fastening the laminated structure and the bipolar plates.

In addition, a cathode current collector 130 may be interposed between the end plate 160 and the bipolar plate 120, which may be laminated directly to the cathode 111 or laminated with the gas diffusion layer 114 interposed between the cathode 111 and the bipolar plate 120, of the cell 110 arranged on a first final end of the cell laminated structure.

Furthermore, an anode current collector 140 may be interposed between the end plate 160 and the anode 112 of the cell 110 arranged on a second final end opposite to the first final end of the cell laminated structure. The anode current collector 140 may be laminated and bonded to contact directly the anode 112 of the second final end, or alternatively, laminated with a separate insertion plate 150 interposed between the anode 112 and the anode current collector 140.

The insertion plate 150 may be made of electrically conductive material or the same material as the bipolar plate without the air flow path 121 and may be manufactured without the air flow path.

The cathode current collector 130 and the anode current collector 140 may be manufactured integrally with the end plate 160.

Meanwhile, a gasket 170 may be interposed between the adjacent bipolar plates 120 that are laminated vertically, and the gasket 170 may be arranged on an outskirt of the components of the cell 110 and to seal thereof. In addition, an air inlet 161 and air outlet 162 that may communicate to an air inlet manifold 181 and the air outlet manifold 182, respectively, may be formed on the outer end plate 160.

Further, inlet manifold holes 122, 171 and outlet manifold holes 123, 172 that may communicate to the air inlet 161 and the air outlet 162, respectively, may be each formed through the bipolar plate 120 and the gasket 170 as being laminated.

Particularly, a channel or the air flow path 121 formed on the first surface of the respective bipolar plate 120 may be formed to connect between the inlet manifold hole 122 and the outlet manifold hole 123 of the corresponding bipolar plate 120.

Accordingly, the inlet manifold hole 122, 171 of the respective bipolar plate 120 and the gasket 170 may form a path for supplying air to the air flow path 121 of the respective bipolar plate 120 while the bipolar plate and the gasket are laminated. In addition, an inlet manifold 181 may be formed, such that the air supplied through the air inlet 161 of the end plate 160 may be distributed to the respective bipolar plate 120 by the inlet manifold holes 122, 171 that are connected vertically.

Further, while the bipolar plate 120 and the gasket 170 are laminated, the respective outlet manifold hole 123, 172 may form a path for discharging air that has passed through the bipolar plate 120, and an outlet manifold 182 may be formed such that the air that has passed through the air flow path 121 of the respective bipolar plate 120 may be discharged to the air outlet 162 of the end plate 160 by the outlet manifold holes 123, 172 that are connected vertically.

In particular, a cooling water flow path 124 may be further formed on the respective bipolar plate 120, such that cooling water may pass through the cooling water flow path 124 to control temperature of a battery 100, and the cooling water flow path may be formed to pass through the inside of the bipolar plate 120.

FIG. 3(a) illustrates an exemplary bipolar plate 120 on which only an air flow path 121 may be formed to supply only air and FIG. 3(b) illustrates an exemplary bipolar plate 120 through inside of which a cooling water flow path 124 may be formed in addition to the air flow path 121 that is engraved on the bipolar plate.

The cooling water may cool a lithium-air battery 100 to be maintained within a proper temperature range, or rapidly elevate the temperature of the lithium-air battery 100 to warm-up at a low temperature condition such as during a turning a vehicle on at a cold whether season. Particularly, the control of the battery may be necessary for preventing deterioration of active material due to temperature and loosening the variation of the reaction speed according to various temperatures simultaneously.

The cooling water, like air, may enter into and exit from cooling water inlet and outlet manifolds (not shown) through inlet unit and outlet unit (not shown) of the end plate 160, and may be distributed to pass through a cooling water flow path 124 of the respective manifold 120 through an inlet manifold and an outlet manifold that may communicate to the cooling water inlet unit and the cooling water outlet unit, respectively.

As such, a cooling water flow path may be configured such that the cooling water may be introduced to pass through the respective bipolar plate 120 and then to be discharged subsequently. In particular, separate cooling water inlet and outlet manifold holes, which are also indicated as reference numerals 125 and 126 in a case of bipolar plate, may be formed on the respective bipolar plate 120 and the gasket 170. Accordingly, a cooling water flow path 124 may be formed inside the respective bipolar plate 120 to connect between the cooling water inlet and outlet manifold holes 125, 126 of the bipolar plate 120.

While the bipolar plate 120 and the gasket 170 are laminated, the respective cooling water inlet manifold hole 125 may form a path for supply the cooling water to the respective cooling water flow path 124 of the bipolar plate 120 and a cooling water inlet manifold may be formed by the cooling water inlet manifold holes 125 that are connected vertically, such that the cooling water supplied through the cooling water inlet of the end plate 160 may be distributed to the respective bipolar plate 120.

Further, while the bipolar plate 120 and the gasket 170 are laminated, the respective cooling water outlet manifold hole 126 may form a path through which the cooling water passing through the bipolar plate 120 is discharged, and a cooling water outlet manifold may be formed by the cooling water outlet manifold holes 126 that are connected vertically, such that the cooling water passing through the cooling water flow path 124 of the respective bipolar plate 120 may be discharged to the cooling water outlet of the end plate 160.

FIG. 4(a) illustrates an exemplary bipolar plate 120 having only an air flow path 121 and FIG. 4(b) illustrates an exemplary bipolar plate 120 having the air flow path 121 and a cooling water flow path 124.

As shown in FIG. 4(a), an air flow path 121 may be formed to connect between an air inlet manifold hole 122 and an air outlet manifold hole 123 in a bipolar plate 120. As shown in FIG. 4(b), a cooling water flow path 124 may be formed inside the bipolar plate 120 to connect between a cooling water inlet manifold hole 125 and a cooling water outlet manifold hole 126.

Further, FIG. 5 illustrates an exemplary embodiment where a channel forming an air flow path 121 may be formed as a plurality. The plurality of channels in parallel that are divided by partitions may be formed to connect between an inlet manifold hole 122 and an outlet manifold hole 123.

FIGS. 4 and 5 illustrate an exemplary embodiment of the air flow path 121 and the cooling water flow path 124 which may be applied to an exemplary lithium-air battery of the present invention, however, the air flow path 121 and the cooling water flow path 124 are not limited to the embodiment as shown in FIGS. 4 and 5, the number, shape and path of the channel forming the air flow path 121 and the cooling water flow path 124 may vary without limitation.

### EXAMPLES

Discharging capacity of cells from various exemplary embodiments were measured and compared to a plurality of cells that are laminated to an unit layer cell in the related art, the test results are described as followings.

When manufacturing an unit layer cell of the comparative embodiment, a lithium foil in a size of about 100×100 mm² was used as an anode and a glass filter (GF/C) in a size of about 102×102 mm² was used as a separation film.

Further, slurry formed by mixing porous carbon powder with a binder was coated to a carbon paper and dried, which was used as an anode in a size of about 90×90 mm².

Further, a liquid electrolyte of about 1M LiTFSI in TEGDME was injected as an electrolyte and a cathode current collector of graphite was processed to have an air flow path and then used.

Further, the charging/discharging was performed with about 25 mA/cell in a range of about 2 to 4.3V to evaluate the charging/discharging of the unit layer cell of the comparative embodiment.

As an example of the present invention, three cells were laminated, each of cells had the same specifications as the comparative embodiment regarding an anode, a cathode, a separation film and an electrolyte, and a bipolar plate made of graphite on which air flow path was formed was laminated with being interposed between an anode and a cathode of adjacent cell.

Further, in order to evaluate the charging/discharging of the laminated cells of the embodiment the charging/discharging was performed with about 25 mA/cell in a range of about 6 to 12.9V.

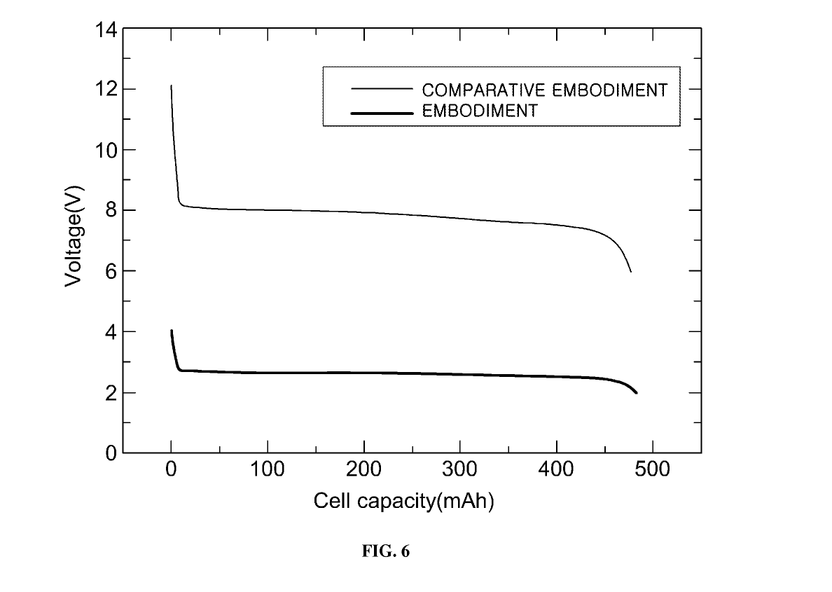

FIG. 6 is a graph illustrating the comparison of discharging capacity of the unit layer cell of the comparative embodiment and the cells of an exemplary embodiment. As shown in FIG.

6, discharging power of a high voltage may be obtained due to the lamination of cells in the laminated cell according to an exemplary embodiment of the present invention.

According to various exemplary lithium-air battery of the present invention, various effects may be obtained.

For example, unit cells each of which includes a cathode, an anode, a separation film and an electrolyte are laminated to be connected electrically in series using a bipolar plate having an air flow path, thereby providing a lithium-air battery package capable of output high voltage. In addition, a bipolar plate having an air flow path is inserted into the respective layer between cells or between a cathode and an anode such that constant air may be distributed and supplied to the cathodes of the entire cells when a discharging is performed. In contrast, in a battery having a conventional air hole, air may not be introduced smoothly into the battery. Further, oxygen produced when the battery is charged may be discharged easily outside since constant air flow may be provided to the respective cell through a bipolar plate. When a battery has a connection structure in series like a conventional lithium ion battery, a terminal needs to be extended outside cells through a tap to connect between cells, and a wiring for connection between cells is necessary. However, according to various exemplary embodiments of the present invention, the wiring components and the volume for the wiring components may be reduced, thereby improving energy density of a battery. Further, such a fixing jig for maintain the interval between cells to supply air to the respective cell in the related art may not be necessary, thereby reducing the volume of a battery and configuring a high density of a battery. Moreover, by controlling constantly temperature of air supplied through air flow path of a bipolar plate, the heat produced inside cells may be controlled and further the temperature of cells may be controlled easily when a bipolar plate including a cooling water flow path is applied.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-air battery, comprising:
a plurality of cells, each of the cells comprising a cathode that uses oxygen in air as an active material, a lithium metal anode, a separation film interposed between the cathode and the anode and an electrolyte for ion transmission,
wherein an electrically conductive bipolar plate having an air flow path for supplying air to the cathode is interposed between the cathode and an anode of adjacent cell while the cells are laminated and an air inlet manifold for distributing air to the air flow path of the respective bipolar plate and an air outlet manifold for allowing the air passing through the air flow path of the respective bipolar plate to be discharged are provided in the lithium-air battery.

2. The lithium-air battery of claim 1, wherein an air flow path having an engraved channel structure is formed on a first surface of the bipolar plate and the first surface of the bipolar plate on which the air flow path is formed is bonded directly to the cathode or bonded to the cathode with a gas diffusion layer interposed between the cathode and the bipolar plate.

3. The lithium-air battery of claim 1, wherein an electrically non-conductive gasket is interposed between the adjacent bipolar plates to be laminated to seal an outskirt of the components of the respective cell.

4. The lithium-air battery of claim 3, wherein an air inlet manifold hole and an air outlet manifold hole are formed through the bipolar plate and the gasket, respectively, and the air inlet manifold hole of the bipolar plate and the air outlet manifold hole of the gasket, which communicate while the bipolar plate and the gasket are laminated, form an air inlet manifold and an air outlet manifold, respectively.

5. The lithium-air battery of claim 4, wherein the air flow path of the bipolar plate is formed to connect between the air inlet manifold hole of the bipolar plate and the air outlet manifold hole of the gasket.

6. The lithium-air battery of claim 1, wherein a cathode current collector and an anode current collector are laminated to both outer ends of a structure formed by laminating a plurality of cells and bipolar plates, respectively, and the cathode current collector is bonded to the bipolar plate and the anode current collector is bonded to the anode or to an electrically conductive insertion plate bonded to the anode.

7. The lithium-air battery of claim 6, wherein electrically non-conductive end plates are assembled to both outer ends of the structure formed by laminating a plurality of cells and bipolar plates to fix and support the components laminated while the cathode current collector and the anode current collector are interposed.

8. The lithium-air battery of claim 7, wherein the end plate has an air inlet unit for supplying air to the air inlet manifold and air outlet unit for discharging air that passes through the air flow path of the bipolar plate and then is discharged through the air outlet manifold to outside.

9. The lithium-air battery of claim 1, wherein a cooling water flow path through which cooling water flows is formed inside the bipolar plate, and a cooling water inlet manifold for distributing the cooling water to the cooling water flow path of the respective bipolar plate and a cooling water outlet manifold for allowing the cooling water passing through the cooling water flow path of the respective bipolar plate to be discharged are provided in the lithium-air battery.

10. The lithium-air battery of claim 9, wherein a cooling water inlet manifold hole and a cooling water outlet manifold hole are formed through the bipolar plate and the gasket, respectively, and the cooling water inlet manifold hole of the bipolar plate and the cooling water outlet manifold hole of the gasket, which communicate while the bipolar plate and the gasket are laminated, form a cooling water inlet manifold and a cooling water outlet manifold, respectively.

11. The lithium-air battery of claim 10, wherein the cooling water flow path of the bipolar plate is formed to connect between the cooling water inlet manifold hole of the bipolar plate and the cooling water outlet manifold hole of the gasket.

12. A lithium-air battery obtainable by laminating a plurality of cells, each of the cells comprises a cathode that uses oxygen in air as an active material, a lithium metal anode, a separation film interposed between the cathode and the anode and an electrolyte for ion transmission,
wherein an electrically conductive bipolar plate having an air flow path for supplying air to the cathode is interposed between the cathode and an anode of adjacent cell while the cells are laminated and an air inlet manifold for distributing air to the air flow path of the respective bipolar plate and an air outlet manifold for allowing the air passing through the air flow path of the respective bipolar plate to be discharged are provided in the lithium-air battery.

13. A vehicle comprising the lithium-air battery of claim 1.

14. A method for producing a lithium-air battery, comprising:
laminating a plurality of cells, each of the cells comprises a cathode that uses oxygen in air as an active material, a lithium metal anode, a separation film interposed between the cathode and the anode and an electrolyte for ion transmission, and
interposing an electrically conductive bipolar plate having an air flow path for supplying air to the cathode between the cathode and an anode of adjacent cell while the cells are laminated,
wherein an air inlet manifold for distributing air to the air flow path of the respective bipolar plate and an air outlet manifold for allowing the air passing through the air flow path of the respective bipolar plate to be discharged are provided in the lithium-air battery.
